(19) United States
(12) Patent Application Publication
(10) Pub. No.: US 2006/0256038 A1
(43) Pub. Date: Nov. 16, 2006

(54) Active matrix array device, electronic device having an active matrix array device and picture quality improvement method for such an electronic device

(75) Inventor: Kenneth R. Whight, Horsham (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/547,808

(22) PCT Filed: Feb. 20, 2004
(86) PCT No.: PCT/IB04/00567

§ 371 Date: Sep. 1, 2005

(30) Foreign Application Priority Data
Mar. 4, 2003 (GB) 0304842.8

(51) Int. Cl. G09G 3/20

(52) U.S. Cl. 345/55

(57) ABSTRACT

An active matrix array device (100) has a plurality of active matrix array elements (110a-i), which each have a charge storage element (112a-I) and a capacative output element (114a-I), and which are coupled to respective addressing conductors (172, 174, 176) and to respective charging conductors (142, 144, 146) via respective thin film transistors (116a-I). The charging conductors (142, 144, 146) are coupled to the respective stages (122, 124, 126) of a driver circuit (120) via respective voltage modification circuits (132, 134, 136), which are responsive to respective voltage waveform generators (252, 254, 256). The respective voltage modification circuits (132, 134, 136) are arranged to modulate the outputs of the stages (122, 124, 126) with a voltage waveform from the respective voltage waveform generators (252, 254, 256) in order to overdrive the addressed matrix array element during a part of its charging cycle. This way, the charge time of the corresponding charge storage element and/or the corresponding output element is reduced.

The invention relates to an active matrix array device comprising a plurality of matrix array elements, each having a charge storage device.

The invention also relates to electronic display device having such an active matrix array device.

The invention further relates to a method for improving the picture quality of such an electronic display device.

Active matrix array devices are being used in many different areas ranging from sensor type applications to display type applications. In the larger display field, active matrix array devices are increasingly competing with the more traditional cathode ray tube displays as the leading technology.

Typically, matrix array devices have crossing sets of addressing conductors and charging conductors, and have matrix array elements coupled to a respective conductor from each set at the crossing intersections. In the case of matrix array display devices, the charging conductors are typically known as the column conductors of the active matrix array device and are arranged to drive a set of values to a row of matrix array elements under control of a column driver circuit, whereas the addressing conductors are typically known as the row conductors of the active matrix array device and are sequentially activated by a further driver circuit like a row driver circuit to select the row of matrix array elements to be addressed. In display devices of this kind, the frequencies of charging and addressing the various rows of active matrix array elements are usually governed by a characteristic of the video signal, like its field frequency, with the timing signals that operate the row and driver circuits being extracted from the video signal by dedicated hardware.

However, the use of such active matrix array devices is not without problems, especially when thin film transistors (TFTs) are being used to enable the programming of the matrix array elements, such as liquid crystal display (LCD) or organic light emitting diode (o-LED) pixels via the conductors coupled to the TFTs. TFTs have relatively poor conductivity in comparison to a monolithic transistor, due to the poorer electron mobility in a TFT. Also, when charging a charge storage element like a capacitor and/or a pixel in a matrix array element for instance for storing a brightness level of the pixel, the conductivity of the TFT decreases with increasing charge stored in the charge storage element, because its source drain voltage drops, which has a detrimental effect on the TFT electron mobility. Consequently, the time required to charge an active matrix array element to its predefined charge value can exceed the available charge time, in which case the amount of charge stored in the matrix element charge storage element is insufficient. In display devices, this leads to faulty brightness levels, which is a highly unwanted phenomenon. The TFT electron mobility can be improved by changing the dimensions of the TFT like increasing the channel width, but leads to a loss of aperture, which is an unwanted side-effect.

A solution to this problem has been provided in US patent application US 2001/0040548 A1, which discloses a driver circuit arrangement for an active matrix LCD device. The driver circuit arrangement includes a ramp-voltage generator coupled to the respective inputs of a plurality of sample and hold circuits, with the ramp-voltage generator generating a voltage waveform at a maximum voltage value in the beginning of the charge cycle of the corresponding LCD pixel. The maximum voltage is maintained for a part of the charge cycle, after which the output voltage is gradually reduced. The digital brightness information of the corresponding pixels is transformed into a pulse width by several latch circuits. The width of the pulse controls how long the corresponding sample and hold circuit samples the voltage waveform from the ramp-voltage generator. Consequently, the addressed pixels of the active matrix array are exposed to a maximum voltage for a substantial part of their charge cycle, thus reducing the time it takes to charge the pixels.

However, this arrangement has several drawbacks. First of all, it is a complex architecture needing a substantial amount of hardware in the driver circuit, which adds to the cost of the active matrix array device. In addition, it is restricted to ramp-voltage based drive signal generation, which means that other driver circuit architectures, like voltage-divider type driver circuits that produce a limited number of discrete brightness outputs, cannot benefit from this arrangement. Furthermore, it is not trivial to avoid overcharging of pixels with this arrangement, especially when the pixel needs to be programmed to a relatively low brightness level.

It is an object of the invention to provide an active matrix array device according to the opening paragraph that is capable of reducing the charge time of a charge storage element in a matrix array element regardless of the way the charge voltage is generated.

It is a further object of the invention to provide an electronic device having such an active matrix array device.

It is yet a further object of the invention to provide a method for improving the picture quality of such an electronic device.

Now, according to an aspect of the invention, there is provided an active matrix array device comprising a plurality of matrix elements, each matrix element comprising a charge storage device, a plurality of charging conductors; each charging conductor being coupled to a subset of the plurality of matrix elements via respective thin film transistors; and a driver circuit having a plurality of stages for generating a plurality of output voltages and a plurality of voltage modification circuits; each stage having an output coupled to one of the charging conductors via one of the voltage modification circuits, each voltage modification circuit being arranged to apply a voltage waveform for modifying the output voltage of the stage to modify a charge time of one of the charge storage devices coupled to the charging conductor.

By coupling a voltage modification circuit to an output of a stage of a driver circuit, the driver circuit can be any known driver circuit, because the modification of the output voltages is unrelated to the actual generation of the output voltages. Thus, the arrangement of the present invention is much more flexible than for instance the arrangement disclosed in US patent application US 2001/0040548 A1. The stage output is modulated by a voltage waveform of a predefined shape, which may be based on simulations of the conductive behaviour of the TFTs used to couple the matrix array elements to their charging conductors. Thus, an overdriving voltage, that is, a voltage larger than the intended voltage to be stored in the charge storage device of the matrix array element, may be applied to the active matrix array element in a first part of a charge cycle of its charge storage element to reduce the charge time of the charge storage element. This is particularly advantageous in high-definition TV applications, where the active matrix array element address time, that is, the allowed time to store a charge in its charge storage device corresponding to a required brightness level, is reduced with respect to normal definition TVs using 50 or 60 Hz refresh rates. It is also advantageous in situations where the active matrix array of a size that, because of the length of the conductors, the impedance of the charging conductors can become a significant influence of the charging times of the matrix array elements. By applying an overdriving voltage to the matrix array element during a part of its charge cycle, this effect is countered and a shorter charge time is obtained to charge the charge storage device of the active matrix array element.

In an embodiment of the present invention, each voltage modification circuit comprises a first input coupled to the output of one of the stages, a second input coupled to a voltage waveform generator and an output coupled to one of the charging conductors. The output voltage from the output of the one of the stages, which may or may not be a fixed value voltage, is modulated with the voltage waveform from the voltage waveform generator. This may for instance be done by multiplying the driver circuit stage output voltage with the voltage waveform from the voltage waveform generator, or by adding the voltage waveform to the driver circuit stage output voltage as an offset. This has the advantage that, in contrast to the driver circuit arrangement described in US patent application US 2001/0040548 A1, the maximum value of the voltage applied to the TFT and associated active matrix array element depends on the required brightness level of the active matrix array element, thus reducing the risk of storing an excessive amount of charge in the charge storage element of the associated active matrix array element. It may, however, be desirable to have the variable maximum voltage limited to an upper limit for practical reasons.

Advantageously, the voltage waveform generator is arranged to generate a first voltage waveform during a first charge cycle of the charge storage device and a second voltage waveform during a second charge cycle of the charge storage device. This is particularly useful for active matrix array devices like an AMLCD device, where the polarity of the pixels is alternated to protect the LC material of the pixel against ageing effects. Since the conductive properties of the TFT are different in a positive and a negative charge cycle, The use of different voltage waveforms in the different charge cycles ensures that despite the differences in the conductive behaviour of the TFT between the both cycles, the charge time of the charge storage device in the addressed active matrix array element becomes comparable for both cycles. Exceptional situations may exist where, in order to match the respective charge times of a charge storage element in the positive and the negative cycles, it may be necessary to reduce the charge time in one of the two cycles, and increase the charge time in the other of the two cycles.

It is a further advantage if the voltage waveform generator is arranged to select a voltage waveform from a plurality of voltage waveforms. This is particularly useful when there is a marked effect on the charging conductor RC time constants depending on the addressing conductor position in the active matrix array element. In other words, the longer the path through the charging conductor, which usually is a column conductor, gets, the larger the RC time through the conductor gets, leading to longer charging times for the charge storage element of the associated active matrix array element. This can be compensated by choosing a voltage waveform that takes the length of the charging conductor into consideration. To this end, the voltage waveform generator may for instance be responsive to some address conductor selection means like the dedicated hardware that generates the timing signals for the row driver circuit in active matrix array display devices, or may operate on the same frequency as the address conductor selection means.

It is another advantage if the voltage waveform generator is programmable. This way, the function that is implemented in the voltage waveform generator may be determined after the active matrix array device is produced, in which case the function may be based upon the differences between intended and actual brightness levels in case of an active matrix array device being used as a display device. This allows compensating for variations in the production process. It is even feasible that such measurements are used to compensate for active matrix array performance degradation during its lifetime, for instance compensation for the ageing effects on the various components of LCD or O-LED based active matrix arrays like the TFTs or the o-LED materials.

In yet another embodiment of the present invention, the plurality of is voltage modification circuits comprises subsets of voltage modification circuits with each subset being coupled to a separate voltage waveform generator. Rather than using a single voltage waveform generator to be applied to all the stages of the driver circuit, the output of each stage of the driver circuit, or the outputs of a small number of stages, is coupled to a separate voltage waveform generator via a separate voltage modification circuit. This has the advantage that variations in the addressing response times of the various active matrix array elements can be compensated for as well. This is particularly relevant in arrangements where the addressing conductor, which typically is a row conductor in an active matrix array display device, has to address a large number of active matrix array elements per addressing cycle, in which case the conductor may have a substantial length, leading to a detrimental effect on the switching behaviour of a TFT towards the far end of the addressing conductor, such as an increased TFT gate delay resulting from the addressing conductor impedance, or the TFT not being switched on properly due to the deterioration of the shape of an addressing pulse provided by the further driver circuit.

According to another aspect of the invention, there is provided an electronic display device comprising an active matrix array device comprising a plurality of matrix elements, each matrix element comprising a charge storage device; and a plurality of charging conductors; each charging conductor being coupled to a subset of the plurality of matrix elements via respective thin film transistors, the electronic device further comprising a driver circuit having a plurality of stages for generating a plurality of output voltages and a plurality of voltage modification circuits; each stage having an output coupled to one of the charging conductors of the active matrix array device via one of the voltage modification circuits, each voltage modification circuit being arranged being arranged to apply a voltage waveform for modifying the output voltage of the stage to modify a charge time of one of the charge storage devices coupled to the charging conductor.

An electronic display device having an active matrix array and driver circuit arrangement of the present invention benefits from the increased performance of this arrangement; the picture refresh rate and the display screen area can be increased without loss of picture quality due to inadequate active matrix array element charging, thus enabling the active matrix array based display devices like AMLCDs to be used successfully as high-end TV products.

According to yet another aspect of the invention, there is provided a method of improving the display quality of such an electronic display device including a programmable voltage waveform generator, comprising the steps of providing the electronic display device with a predefined test image; measuring a manifestation of the test image on the active matrix array of the electronic display device; comparing the manifestation of the test image with the predefined test image; if a difference between the manifestation of the test image with the predefined test image is observed providing the electronic display device with an updated voltage waveform for compensating the observed difference; and storing the updated voltage waveform in the programmable voltage waveform generator.

Such a method can be used to calibrate the electronic device after production as well as to compensate for ageing effects in the active matrix array device of the electronic display device. Consequently, the picture display quality of the electronic device can be improved after production of the electronic device and can be maintained over a longer period of its lifetime.

The invention is described in more detail and by way of non-limiting examples with reference to the accompanying drawings, wherein:

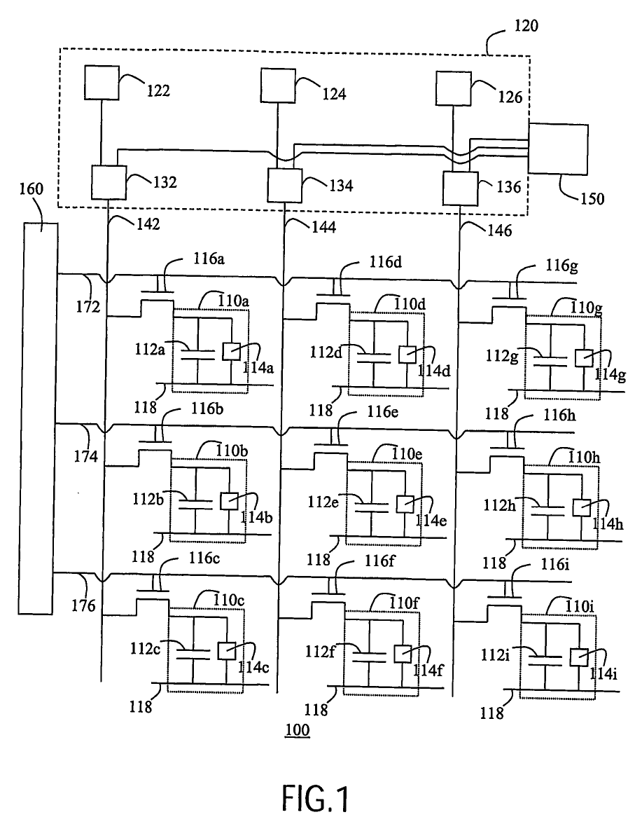

FIG. 1 schematically depicts an embodiment of an active matrix array device according to the present invention;

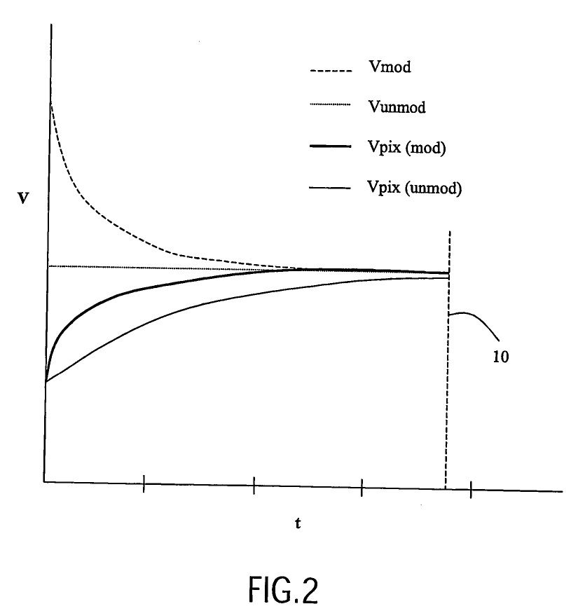

FIG. 2 schematically depicts a graph indicating the effect of applying a voltage waveform to an active matrix array element on the charge time of the charge storage element of the active matrix array element;

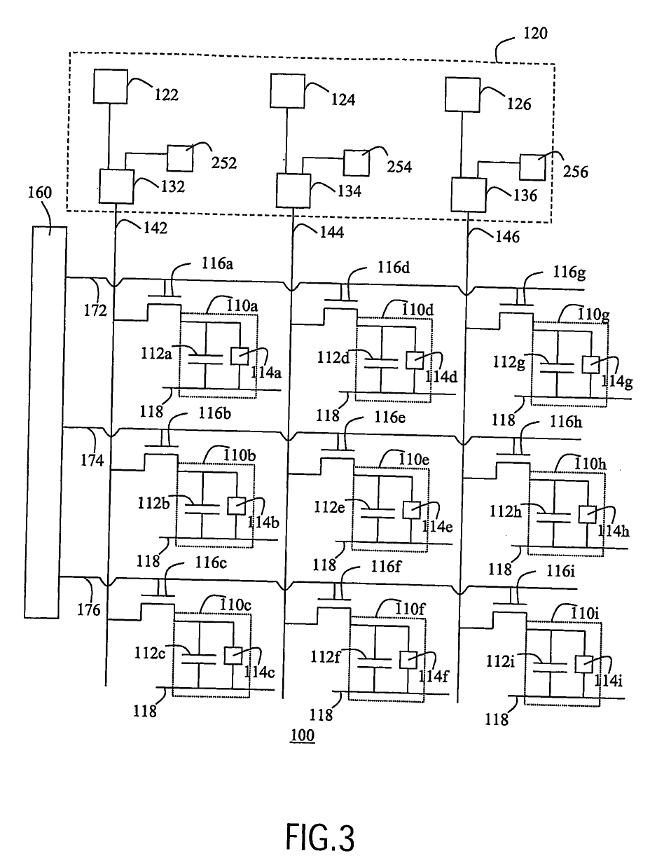

FIG. 3 schematically depicts another embodiment of an active matrix array device according to the present invention; and

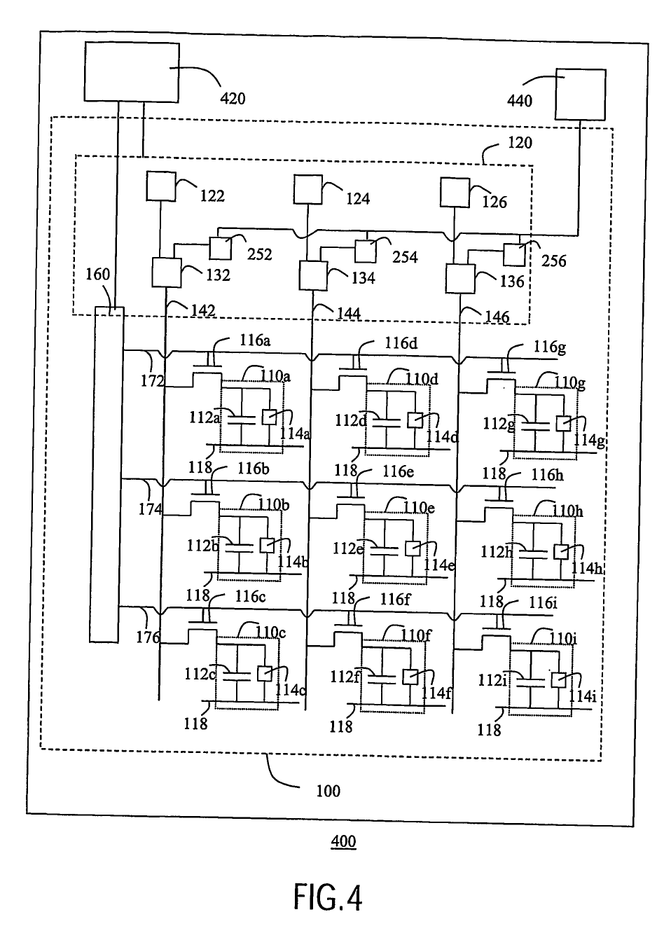

FIG. 4 schematically depicts an electronic display device according to the present invention.

It should be understood that the Figures are merely schematic and are not drawn to scale. In particular, certain dimensions such as the thickness of layers or regions may have been exaggerated whilst other dimensions may have been reduced. It should also be understood that the same reference numerals are used throughout the Figures to indicate the same or similar parts.

The active matrix array device 100 in FIG. 1 has a plurality of active matrix array elements 110a-i, which include respective charge storage elements 112a-i and output elements 114a-i, which may be capable of storing a charge as well. The charge storage elements 112a-i are each arranged to maintain a state of one of the output elements 114a-i over a predefined period of time. In the case of the active matrix array device 100 being a display device, the output elements 114a-i may for instance be LC or poly-LED cells. In FIG. 1, the charge storage elements 112a-i are coupled between respective thin film transistors (TFTs) 116a-i and a common electrode 118. It should, however, be appreciated that this is by way of non-limiting example only; other arrangements where the common electrode 118 has been replaced by other electrode arrangements known in the art, such as arrangements where dedicated conductors or neighbouring addressing conductors function as electrode, are equally feasible. Each of the TFTs 116a-i have a source coupled to one of the charging conductors 142, 144 and 146 that form the column conductors of active matrix array device 100 and a gate coupled to one of the addressing conductors 172, 174 and 176 that form the row conductors of active matrix array device 100. Each of the charging conductors 142, 144 and 146 is coupled to a respective stage 122, 124 and 126 of the driver circuit 120 via a respective voltage modification circuit 132, 134 and 136.

The driver circuit 120 may be any row or column driver circuit known to a person skilled in the art, and may be arranged to process an analog or a digital input signal. Each of the addressing conductors 172, 174 and 176 is coupled to a further driver circuit 160, which may be any row or column driver circuit known to a person skilled in the art. In addition, the active matrix array device 100 may be a display device, but the present invention can be applied to other active matrix array application domains as well, like sensor or memory devices. Furthermore, it is emphasized that the number of elements like the matrix array elements and the conductors shown in FIG. 1 and the following Figs. is chosen for reasons of clarity only; it will be appreciated by those skilled in the art that the active matrix array devices of the present invention typically include a substantially larger number of such elements than shown in the Figs.

The voltage modification circuits 132, 134 and 136 each have a first input coupled to an output of a respective stage 122, 124 and 126 and a second input coupled to a voltage waveform generator 150. The voltage waveform generator 150 may include a memory device (not shown) coupled to a digital-to-analog converter (not shown) for generating a predefined analog waveform that is stored in a digitized form in the memory device, or may be arranged to generate the voltage waveform in another known way. The memory device may be a programmable device like a random access memory or a look-up table, which may be part of a field programmable gate array (FPGA) device implementing the voltage waveform generator. The use of a programmable memory device enables the programming of a voltage waveform into the memory after the active matrix array device has been fabricated, which enables compensating for the effects of process variations and/or ageing effects of the active matrix array device, which will be explained in more detail below.

The arrangement of the voltage waveform generator 150 and the voltage modification circuits 132, 134 and 136 can be used to compensate for the problems that originate from the limited electron mobility characteristics of TFTs 116a-i. Typically, the voltage modification circuits 132, 134 and 136 will provide respective charging conductors 142, 144 and 146 with an overdrive voltage, that is, a higher voltage than the intended voltage to be stored in the respective associated charge storage devices of the matrix array elements 110a-i that are switched on by one of the addressing conductors 172, 174 and 176 so as to reduce the time it takes to charge the associated charge storage devices, that is, the charge storage devices 112a-i and/or the output elements 114a-i, during a charge cycle of the corresponding active matrix array elements 110a-i.

This principle is demonstrated in FIG. 2. V_{unmod} is the output voltage of one of the stages 122, 124 and 126 and is defined as the potential difference between the stage of the driver circuit 120 and the common electrode 118 of the active matrix array device 100. Therefore, V_{unmod} typically corresponds with the intended potential difference across the addressed charge storage element, that is, one of the charge storage elements 112a-i and/or one of the output elements 114a-i, which may be capacitors or equivalent devices. V_{pix(unmod)} demonstrates the actual potential difference over the addressed charge storage element after time period t. Typically, V_{pix(unmod)} lags behind the voltage V_{unmod} applied to the appropriate charging conductor, because of the limited electron mobility of the TFT that couples the charging conductor to the charge storage element. Also, as the potential over the charge storage element approaches the intended voltage V_{unmod}, the source-drain voltage of the associated TFT approaches 0V, which also adds to the charge time of the charge storage element. This may lead to situations where at the end of a charge cycle, as indicated by dotted line 10, when the associated TFT is switched off, V_{pix(unmod)} across the charge storage element differs to such an extent from V_{unmod} that deviations from the intended performance of the associated output element, that is, one of the output elements 114a-i, occur. In the case of the output element performing a display function, this typically means that a difference in the brightness level of the output element from the intended brightness level can be observed, which is a highly unwanted situation.

This can be avoided by providing a charging conductor with a voltage V_{mod}, which is generated by one of the voltage modification circuits 132, 134 and 136 by combining a voltage waveform having a similar shape as V_{mod} with is the output voltage V_{unmod} of the corresponding stage of the driver circuit 120. The voltage waveform may be generated internally in each of the voltage modification circuits 132, 134 and 136, for instance by including the functionality of voltage waveform generator 150 in each of the voltage modification circuits 132, 134 and 136, or may be obtained from one or more external voltage waveform generators like voltage waveform generator 150. The application of V_{mod} to the charging conductor has the effect that the addressed charge storage device is initially overdriven by the driver circuit 120, which causes the charge storage device to become charged more rapidly, as can be seen from the corresponding charging profile V_{pix(mod)}, thus more effectively utilizing the high mobility region of the associated TFT.

The required voltage waveform used to modify V_{unmod} can be obtained by modelling the response time of the charge storage element as depicted in V_{pix(unmod)} to a charging voltage V_{unmod}.

An example of how such a required voltage waveform can be obtained is given below. The response of a voltage v across the matrix array element 110a-i to a constant voltage v₀ on the associated charging conductor 142, 144 or 146 as a function of time can be approximated by

$$\frac{ⅆ v}{ⅆ t} + \frac{v}{r c} = \frac{{v}_{0}}{r c} \qquad ( 1 )$$

where rc is the effective time constant of the charge storage device 112a-i and/or the capacitive ouput element 114a-i of the matrix array element 110a-i. Equation (1) has solution

$$v = {v}_{0} ( 1 - {aⅇ}^{- \frac{t}{rc}} ) \qquad ( 2 )$$

To obtain a shorter charge time for the charge storage device, equation (2) can be modified to

$$v = {v}_{0} ( 1 - {aⅇ}^{- \frac{t}{m}} ) \qquad ( 3 )$$

where m<rc. To achieve this it is noted that equation (1) can be rewritten to

$$\frac{ⅆ v}{ⅆ t} + \frac{v}{r c} = \frac{f ( t )}{r c} \qquad ( 4 )$$

where f(t) is the overdriven column voltage as a function of time. To obtain the desired voltage waveform, equation (3) is substituted into equation (4) to obtain

$$f ( t ) = {v}_{0} \{ 1 + {aⅇ}^{- \frac{t}{m}} ( \frac{rc}{m} - 1 ) \} \qquad ( 5 )$$

defining the desired voltage waveform.

Alternatively, in the case of the voltage modification circuit 132, 134 and/or or the voltage waveform generator 150 being programmable, such a voltage waveform can be based on performance measurements after production of the active matrix array device. It will be obvious to those skilled in the art that the amount of overdriving can be varied to match the charge time of the charge storage elements 112a-i and/or output elements 114a-i to a predetermined charge period.

Now, on turning back to FIG. 1, it is pointed out that the output voltage of a stage 122, 124 or 126 of the driver circuit 120 can be combined with a voltage waveform in several ways. One possible way is by multiplying the output voltage of the stage with the voltage waveform. This has the advantage that for all non-zero output voltages the relative amount of overdriving is a fixed factor, while at an output of 0V of one of the stages 122, 124 or 126 the output of the associated voltage modification circuit 132, 134 or 136 remains 0V as well. Such a voltage modification circuit can be implemented by means of an analog multiplier or by means of pulse width modulation techniques. A simple implementation would be a mere transistor, with the output of one of the stages 122, 124 and 126 coupled to its gate and the voltage waveform generator 150 coupled to the source of the transistor. Alternatively, the voltage modification circuits 132, 134 or 136 may be micro controllers having their respective outputs coupled to respective charging conductors 142, 144 and 146 via a digital-to-analog converter, in which case the inputs of the voltage modification circuits 132, 134 or 136 may be fed with digital rather than analog signals, which would obviate the need of a digital to analog conversion step in the case the stages 122, 124 and 126 of the driver circuit 120 using digital input data. In addition, it would also obviate the need for digital to analog conversion step in the voltage waveform generator 150.

Preferably, the voltage waveform generator 150 is capable of generating different voltage waveforms. This is for instance advantageous when the active matrix array device 100 has LC output elements 114a-i, which typically are addressed in alternating cycles of reversing polarity to prevent or delay the degradation of the LC material. Typically, the conductivity characteristics of the associated TFTs 116a-i in the positive cycle differ from their conductivity characteristics in the negative cycle. By application of different voltage waveforms in the two cycles, the different delays in the charge times of the associated charge storage elements 112a-i that arise from these different conductivity characteristics can both be effectively compensated. In extreme situations, it may be necessary to slow down the charge time of a charge storage element 112a-i in one of these two cycles to get a good match between the charge times in the respective cycles. The voltage waveform generator 150 may be made responsive to the field or frame period of the active matrix array device 100, that is the time between two successive addresses of one and the same addressing conductor 172, 174 or 176.

The conductivity characteristics of the TFTs 116a-i are not the only factors that influence the RC time constants of the charge storage elements 112a-i. An increasing length of the conductive path between one of the charge storage elements 112a-i and the corresponding stage 122, 124 or 126 of the driver circuit 120 increases the RC time constant of that charge storage element. In other words, the charge storage elements 112a, 112d and 112g that are coupled to addressing conductor 172 have a shorter RC, time than for instance the charge storage elements 112c, 112f and 112i that are coupled to addressing conductor 176, because the latter three charge storage elements experience a larger impedance in the path between respective stages 122, 124 and 126 and respective TFTs 116c, 116f and 116i due to the increased length of the current path through the charging conductors 142, 144 and 146.

To compensate for this effect, the voltage waveform generator 150 can be configured to select a suitable voltage waveform from a plurality of voltage waveforms, each of these voltage waveforms being designed to compensate for a particular length of the current path between one of the stages 122, 124 and 126 and one of the charge storage devices 112a-i. The plurality of waveforms may contain different sets of voltage waveforms for the different polarities of the charging cycles. The voltage waveform generator 150 may be made responsive to addressing conductor selection means like the aforementioned dedicated hardware used to generate the timing signals from a video signal to control the timing of the further driver circuit 160 or the driver circuit 120 in the case of the active matrix array device 100 being a display device, and a new voltage waveform may be selected upon selection of a new addressing conductor, or may be selected after a number of addressing conductors have been addressed, effectively grouping subsets of the addressing conductors 172, 174 and 176 of active matrix array device 100 into different groups.

The length of the current path between the further driver circuit 160 and a gate of one of the TFTs 116a-i can also have a marked effect on the gate delay of the TFTs 116a-i coupled to the corresponding charge storage elements 112a-i. For instance, TFT 116g coupled to charge storage element 112g on charging conductor 146 may experience a larger gate delay than TFT 116a coupled to charge storage element 112a on charging conductor 142, because the effective length of the addressing conductor 172 between the further driver circuit 160 and the gate of TFT 116g is longer than the effective length of the addressing conductor 172 between the further driver circuit 160 and the gate of TFT 116a. Consequently, the gate of TFT 116g experiences a higher impedance on the addressing conductor 172 than the gate of TFT 116a does, which means that TFT 116g is turned on more slowly than TFT 116a. Thus, the effective charge period of charge storage element 112g is shorter than that of charge storage element 116a.

Another detrimental effect that can lead to a similar effect on these charging times is the deterioration of the address pulse provided by the further driver circuit 160 to switch on the TFTs. Upon progression of the address pulse along an addressing conductor 172, 174 or 176, the pulse shape can deform, which may lead to the TFTs that are further away from the further driver circuit 160 being less effectively switched on than those nearer to the further driver circuit 160.

This can be compensated for by supplying a subset of the voltage modification circuits 132, 134 and 136 with separate voltage waveform generators 252, 254 and 256, as shown in FIG. 3. The subset of the voltage modification circuits may contain as little as a single voltage modification circuit, in which case each of the modification circuits has its own voltage waveform generator, or may contain a small number of voltage modification circuits, in which case the charging conductors of the active matrix array device 100 are divided into sections that each have their own separate voltage waveform generator. The charging conductors 142, 144 and 146 can be separated into groups based upon the gate delay characteristics of the associated TFTs 116a-i, with separate groups being supplied by separate voltage waveform generators 252, 254 and 256, each of the voltage waveform generators 252, 254 and 256 compensating for the section characteristic gate delay of the associated TFTs.

Preferably, the voltage waveform generators 252, 254 and 256 will contain different pluralities of waveforms to compensate for the different polarity cycles when applicable, the dependency of the RC time of the associated charge storage devices 112 a-i and/or output devices 114a-i on addressing conductor position and the dependency of the RC time of the associated charge storage devices 112 a-i and/or output devices 114a-i on charging conductor position. It is emphasized that the various embodiments of the voltage waveform generator 150 as shown in FIG. 1 and describe in its detailed description may also be applied to the separate voltage waveform generators 252, 254 and 256 without departing from the scope of the invention.

FIG. 4 shows a preferred embodiment of an electronic display device 400 having an active matrix array device 100 according to the present invention. The driver circuit 120 and the further driver circuit 160, which may be an integral part of active matrix array device 100 or may be separate components, are coupled to a power supply 420. The voltage waveform generators 252, 254 and 256 are coupled to a further power supply 440, which may be an integral part of power supply 420. For reasons discussed above, the electronic display device 400 is capable of providing an improved picture quality compared with conventional display devices in terms of brightness control. In addition, if the voltage waveform generators 252, 254 and 256 are programmable, the quality of the electronic display device 400 may be improved after its manufacture or during its lifecycle. Typically, electronic display devices suffer from slowly deteriorating picture quality because of ageing effects of the various components, like the degradation of TFTs 116a-i and/or the degradation of the chemical compounds used in output devices 114a-i, that are used as building blocks of the active matrix array device 100. The display quality can be improved by the following method.

In a first step, the electronic display device 400 is provided with a predefined test image, and in a second step, a manifestation of the test image on the active matrix array of the electronic display device 400 is measured. This manifestation may be an actual image on the display area of the electronic display device 400, or may be a collection of electrical signals on the conductors of the active matrix array device 100. In the case of the manifestation being an actual image, the measurement can be done with known optical sensors, which may be temporarily attached to the screen. This has the advantage that light pollution from the surroundings is minimized. For this reason, it may be preferable to perform the measurement in a dark room.

In a next step, the measured manifestation of the test image is compared with the predefined test image. In case of the manifestation of the test image being a collection of electrical signals, the value of these signals is compared with the intended values corresponding to the test image. If a difference between the manifestation of the test image with the predefined test image is observed the electronic display device 400 is provided with an updated voltage waveform for compensating the observed difference, which is stored in the programmable voltage waveform generator 150, or when present, in one of the separate programmable voltage waveform generators 252, 254 and 256. These steps may be repeated until all the voltage waveforms stored in the voltage waveform generator 150 or in the separate programmable voltage waveform generators 252, 254 and 256 have been updated.

The updated voltage waveform may be calculated based on the voltage waveform stored in the programmable voltage generator 150 or one of the programmable voltage waveform generators 252, 254 and 256. To this end, the method may comprise an additional step of retrieving the voltage waveform from the electronic display device 400.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An active matrix array device comprising:
a plurality of matrix elements, each matrix element comprising a charge storage device;
a plurality of charging conductors; each charging conductor being coupled to a subset of the plurality of matrix elements via respective thin film transistors; and
a driver circuit having a plurality of stages for generating a plurality of output voltages and a plurality of voltage modification circuits; each stage having an output coupled to one of the charging conductors via one of the voltage modification circuits, each voltage modification circuit being arranged to apply a voltage waveform for modifying the output voltage of the stage to modify a charge time of one of the charge storage devices coupled to the charging conductor.

2. An active matrix array device as claimed in claim 1, wherein each voltage modification circuit comprises:
a first input coupled to the output of one of the stages;
a second input coupled to a voltage waveform generator; and
an output coupled to one of the charging conductors.

3. An active matrix array device as claimed in claim 2, wherein
each modification circuit implements a multiplication function.

4. An active matrix array device as claimed in claim 2, wherein the voltage waveform generator is arranged to generate a first voltage waveform during a first charge cycle of the charge storage device and a second voltage waveform during a second charge cycle of the charge storage device.

5. An active matrix array device as claimed in claim 2, wherein the voltage waveform generator is arranged to select a voltage waveform from a plurality of voltage waveforms.

6. An active matrix array device as claimed in claim 2, wherein the voltage waveform generator is programmable.

7. An active matrix array device as claimed in claim 2, wherein the plurality of voltage modification circuits comprises subsets of voltage modification circuits with each subset being coupled to a separate voltage waveform generator.

8. An electronic display device comprising:
an active matrix array device comprising:
a plurality of matrix elements, each matrix element comprising
a charge storage device;
a plurality of charging conductors; each charging conductor being coupled to a subset of the plurality of matrix elements via respective thin film transistors; the electronic display device further comprising:
a driver circuit having a plurality of stages for generating a plurality of output voltages and a plurality of voltage modification circuits; each stage having an output coupled to one of the charging conductors via one of the voltage modification circuits, each voltage modification circuit being arranged to apply a voltage waveform for modifying the output voltage of the stage to modify a charge time of one of the charge storage devices coupled to the charging conductor.

9. An electronic display device as claimed in claim 8, wherein
each voltage modification circuit comprises:
a first input coupled to the output of one of the stages;
a second input coupled to a voltage waveform generator; and
an output coupled to one of the charging conductors.

10. An electronic display device as claimed in claim 9, wherein each modification circuit implements a multiplication function.

11. An electronic display device as claimed in claim 9, wherein the voltage waveform generator is arranged to generate a first voltage waveform during a first charge cycle of the charge storage device and a second voltage waveform during a second charge cycle of the charge storage device.

12. An electronic display device as claimed in claim 9, wherein the voltage waveform generator is arranged to select a voltage waveform from a plurality of voltage waveforms.

13. An electronic display device as claimed in claim 9, wherein the voltage waveform generator is programmable.

14. An electronic display device as claimed in claim 9, wherein the plurality of voltage modification circuits comprises subsets of voltage modification circuits with each subset being coupled to a separate voltage waveform generator.

15. An electronic display device as claimed in claim 9, wherein the matrix array elements comprise respective output elements comprising a liquid crystal material.

16. An electronic display device as claimed in claim 9, wherein the matrix array elements comprise respective output elements comprising a organic light emitting diode material.

17. A method of improving the display quality of an electronic display device as claimed in claim 13, comprising the steps of:
providing the electronic display device with a predefined test image;
measuring a manifestation of the test image on the active matrix array device of the electronic display device;
comparing the manifestation of the test image with the predefined test image;
if a difference between the manifestation of the test image with the predefined test image is observed providing the electronic display device with an updated voltage waveform for compensating the observed difference; and
storing the updated voltage waveform in the programmable voltage waveform generator.
